(19) United States
(12) Patent Application Publication
(10) Pub. No.: US 2006/0016095 A1
(43) Pub. Date: Jan. 26, 2006

(54) Wood steaming apparatus and method of heating wood

(76) Inventors: Peter Gibbs, Wellington (NZ); Keith A Robertson, Wellington (NZ); Malcolm R Fredric, Wellington (NZ)

Correspondence Address: PILLSBURY WINTHROP, LLP, P.O. BOX 10500, MCLEAN, VA, 22102, US

(21) Appl. No.: 10/451,186

(22) PCT Filed: Dec. 20, 2001
(86) PCT No.: PCT/NZ01/00292

§ 371 Date: Oct. 7, 2003

(30) Foreign Application Priority Data
Dec. 20, 2000 (NZ) 509021

(51) Int. Cl. F26B 7/00

(52) U.S. Cl. 34/389; 34/396

(57) ABSTRACT

A wood steaming apparatus for heating wood (4) within chamber (1). Water within trough (8) is heated to generate “wet steam”. Condensate is collected in collector (10) and pumped by pump (11) back to trough (8). The use of “wet steam” results in relatively uniform heating whilst maintaining relatively consistent moisture content throughout the wood. The closed loop design minimises the production of polluting condensate waste.

### FIELD OF THE INVENTION

The present invention relates to a wood steaming apparatus and a method of heating wood. More particularly, the present invention relates to a wood steaming apparatus including a trough containing a fluid which is heated to generate steam to heat the wood. A method of use is also disclosed.

### BACKGROUND OF THE INVENTION

In the preparation of certain wood products, such as ply wood and veneer, it is necessary to peel or slice a thin continuous layer from a log for further processing. Typically, a log Is debarked and peeled on a lathe to create a continuous thin sheet suitable for forming ply wood or other products. The sheet so formed is then dried.

When peeling a sheet of wood on a lathe it is desirable for the log to be at a certain temperature and have a certain moisture content. It is normally desirable for the core temperature of the log to be above about 40° C. and to have an increased moisture content. It is desirable for the moisture content to be relatively uniform throughout the log.

One technique currently employed is to inject steam directly into a chamber containing logs to be heated. This approach has the disadvantage that the steam Is relatively “dry” and the outer surface of the log tends to be drier than the core. This can result in splitting and/or cracking of the sheet. Further, the steam is simply injected and then disposed of as a waste as the condensation is collected. This may create undesirable pollutants and adds significant cost In terms of treatment chemicals applied to water supplied to the boiler.

### DISCLOSURE OF THE INVENTION

It is an object of the present inventioni to provide a wood steaming chamber and method of heating wood that overcomes these disadvantages or at least provides the public with a useful choice. According to. a first aspect of the invention there is provided a wood steaming apparatus including:
a chamber;
a trough for containing a fluid;
heating means for heating a fluid within the trough to generate steam; and
a fluid collection system for collecting condensed fluid and returning it to the trough.

The heating means is preferably a heat exchanger positioned in the trough and supplied with steam by a steam boiler. The fluid collection system may include a fluid collector for collecting condensate and a pump which pumps fluid from the fluid collector to the trough. In an alternative embodiment the trough may be positioned so that condensate is returned to the trough by gravity.

According to a further aspect of the invention there Is provided a method of heating wood including the steps of:
placing wood within a chamber having a trough containing fluid therein;
heating the fluid within the trough to generate steam to heat the wood; and
collecting condensed fluid and returning it to the trough.

The steam is atmospheric steam (“wet steam”) and conditions are preferably maintained such that the dry bulb temperature within the chamber is between 60-98° C., preferably 80-98° C., most preferably 90-98° C.

The fluid is preferably heated by a heat exchanger supplied with steam from a boiler in a closed loop configuration.

A number of logs are preferably heated simultaneously. The logs may typically be greater than 150 mm in diameter and greater than 1.5 metres in length. The logs are typically heated so that the core temperature is greater than 40°, typically between 40 to 85° C., more preferably between 50 to 60° C. The fluid is preferably steam and is heated to about 99 to 100° C. The wood is generally heated for between 4 to 24 hours.

### BRIEF DESCRIPTION OF THE DRAWINGS

The invention will now be described by way of example with reference to the accompanying drawings in which:

FIG. 1: shows an end view of a wood steaming chamber according to a first embodiment.

FIG. 2: shows an end view of a wood steaming chamber according to a second embodiment.

FIG. 3: shows a side view of a wood steaming chamber shown in FIG. 2.

### DETAILED DESCRIPTION OF THE DRAWINGS

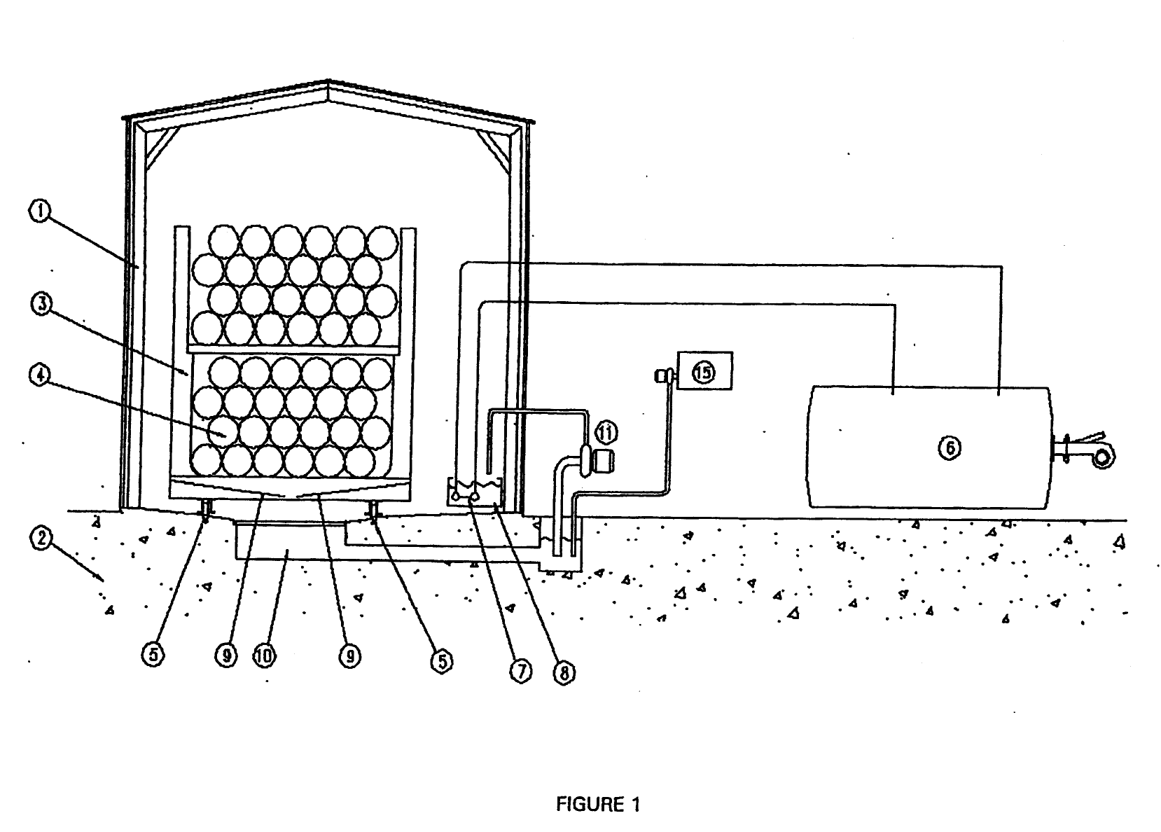

Referring firstly to FIG. 1 a chamber 1 is erected upon a concrete foundation 2. A trolley 3 containing logs 4 is moveable along rails 5. A boiler 6 provides steam to heat exchanger elements 7 with condensate being returnedto boiler 6. The heat exchanger elements are provided within a trough 8 filled with water. Deflector plates 9 direct condensate into collector 10. Pump 11 pumps condensate from collector 10 to trough 8.

Chamber 1 is insulated and has an opening and closing door through which trolleys can be conveyed. The trolleys 3 move on rails when moved into and out of the chamber. In use, boiler 6 provides steam to heat exchanger element 7 which causes steam, at a temperature of about 100° C. (depending upon atmospheric pressure), to be generated by trough 8. The steam generated by this method is relatively “wet steam” which, when it condenses upon the logs, transfers heat In a gentle manner to the logs. The relatively “wet” nature of the steam ensures a relatively consistent moisture content throughout the logs.

As condensate forms on the logs it drops under the force of gravity and is channelled by deflector plates 9 into collector 10. Pump 11 pumps the condensate back into trough 8 to form a closed loop operation.

The operation of two closed loop systems has a number of benefits. Firstly, as the steam generated by boiler 6 passes through heat exchanger element 7 and is returned to boiler 6 the same operating fluid can be used continuously. The operating fluid used In boilers requires chemical treatment and by utilising a closed loop system for the operating fluid there Is no loss of treatment chemicals. In the second closed loop the recycling of water from trough 8 via collector 10 and pump 11 minimises the production of polluting condensate waste which may require treatment before being disposed of. Trough 8 may simply be heated until dry and any solids removed at periodic intervals.

Further to these advantages are the aforementioned advantages of consistent heating throughout the log and consistent moisture content.

It may be desirable to treat and/or filter the condensate collected in collector 10. A filter at the top of collector 10 may prevent debris passing into collector 10. A filter may also be provided in pump 11 to remove particulate matter. It may also be desirable to provide chemically treat the condensate to control pH, reduce foaming or cool the condensate. Standard chemical techniques may be utilised to control pH and foaming. Chemicals may be dispensed by dispenser 15 including a storage reservoir and a solenoid controlled valve. As fluid Is released from the logs during heating, additional water may be added to dilate the condensate. The condensate may also be cooled prior to release, where condensate is removed from the system.

In use the chamber may be provided with a temperature sensor to sense conditions within the chamber. The sensor will preferably include a dry bulb which provides an electrical signal to a controller. The operation of boiler 6 may be controlled accordingly. A suitable controller may be a Dry Spec L™ controller.

Typically logs will be exposed to steam within chamber 1 for between 4 to 24 hours with the dry bulb temperature being maintained between 60-98° C., preferably 80-98° C., more preferably 90-98° C.

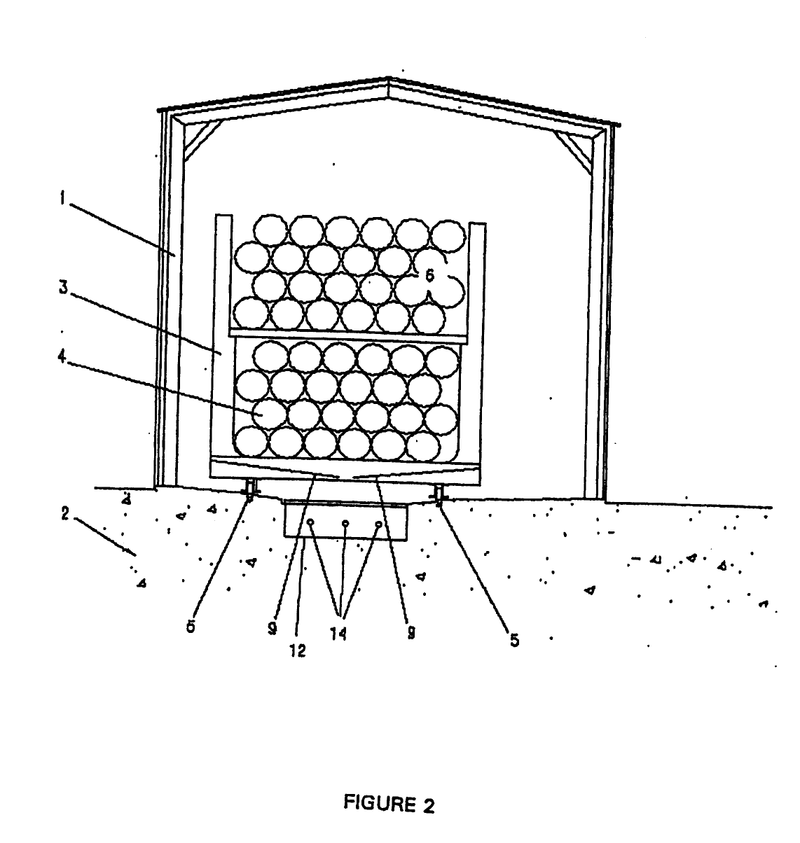

Referring now to FIG. 2 an alternative embodiment is shown. The configuration is different to that shown in FIG. 1 in that trough 1 2 is provided underneath trolley 13 and positioned so as to collect condensate directly therein. This avoids the need for pump 11 to recycle condensate back to trough 8. Heat exchanger elements 14 are provided in trough 12 in a normal manner. Otherwise the apparatus is as per that shown in FIG. 1.

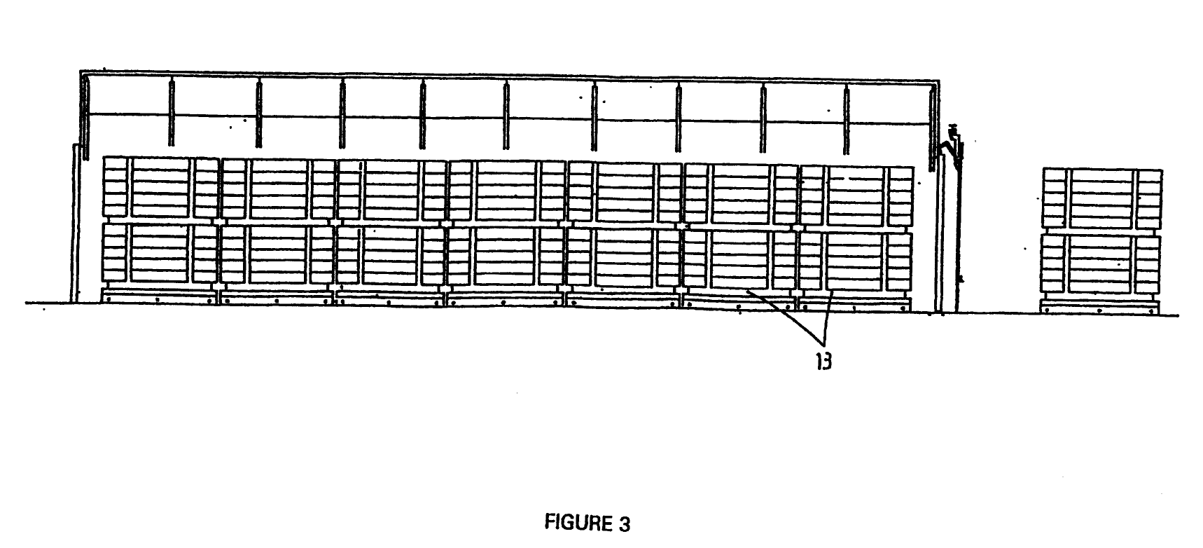

Referring now to FIG. 3 a side view of the chamber shown In FIG. 2 is shown. The chamber is shown to have a sufficient size to accommodate seven trolleys 13 therewithin, although this may be adjusted to meet any particular requirements. The trolleys are all moved along common rails to facilitate easy loading and unloading of the chamber.

It will thus be seen that the invention provides a steaming chamber and method of heating wood that heats the wood relatively uniformly and maintains a relatively consistent moisture content throughout the wood.

The amount of condensate material is also minimised and the cost of treatment chemicals required by the boiler is reduced.

Where in the foregoing description reference has been made to integers or components having known equivalents then such equivalents are herein Incorporated as if individually set forth.

Although this invention has been described by way of example It is to be appreciated that improvements and/or modifications may be made thereto without departing from the scope of the present invention as defined in the appended claims.

1. A wood steaming apparatus including:
a chamber;
a trough for containing a fluid;
heating means for heating a fluid within the trough to generate steam; and
a fluid collection system for collecting condensed fluid and returning it to the trough.

2. An apparatus as claimed in claim 1 wherein the trough is positioned within the chamber such that, in use, it is located underneath wood to be heated.

3. An apparatus as claimed in claim 1 including a collector for collecting condensate and a pump for pumping condensate from the collector to the trough.

4. An apparatus as claimed in any one the preceding claims including a trolley having a drip tray on the underside thereof which directs condensate to exit at a central region underneath the trolley.

5. An apparatus as claimed in any preceding claim wherein the heating means includes a heat exchanger.

6. An apparatus as claimed in claim 5 wherein the heat exchanger is powered by a boiler.

7. An apparatus as claimed in any preceding claim including a chemical dispenser for dispensing condensate treatment chemicals.

8. A method of heating wood including the steps of:
placing wood within a chamber having a trough containing fluid therein;
heating the fluid within the trough to generate steam to heat the wood; and
collecting condensed fluid and returning it to the trough.

9. A method as claimed in claim 8 wherein the dry bulb temperature within the chamber is maintained between 60-98° C.

10. A method as claimed In claim 8 wherein the dry bulb temperature within the chamber is maintained between 80-98° C.

11. A method as claimed in claim 8 wherein the dry bulb temperature within the chamber is maintained between 90-98° C.

12. A method as claimed in any one of claims 8 to 11 wherein chemicals are added to the condensate periodically to control the pH and/or foaming properties of the condensate.

13. A method as claimed in any one of claims 8 to 12 wherein water is. added periodically to dilute the condensate.

14. A method as claimed in any one of claims 8 to 13 wherein the condensate is cooled before being expelled from the apparatus.
